(19) United States
(12) Patent Application Publication
(10) Pub. No.: US 2004/0081307 A1
(43) Pub. Date: Apr. 29, 2004

(54) IP network system and H.323 gatekeeper

(75) Inventors: Keigo Fujiwara, Tokyo (JP); Takanobu Ihara, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/688,906

(22) Filed: Oct. 21, 2003

(30) Foreign Application Priority Data
Oct. 24, 2002 (JP) 310147 / 2002

(51) Int. Cl. H04L 12/66; H04J 3/16; H04J 3/22

(52) U.S. Cl. 379/220.01; 370/352; 370/465

(57) ABSTRACT

An IP network system and an H.323 gatekeeper for easily performing voice communication between an existing system such as an IP-PBX system not employing the H.323 protocol and a system employing the H.323 protocol. There are connected an H.323 gatekeeper, H.323 terminal, an IP-PBX and an IP component to an IP network. The H.323 gatekeeper installs therein a software to perform protocol conversion between the PHS protocol and the H.323 protocol. Accordingly, voice communication between the H.323 terminal and the IP component can be realized.

### BACKGROUND OF THE INVENTION

The present invention relates to an IP network system and an H.323 gatekeeper, and in particular, to an IP network system and an H.323 gatekeeper for performing voice communication between systems with different protocols via an IP network.

### DESCRIPTION OF THE RELATED ART

Recently, there has been disclosed many techniques for exchanging voice information on an IP network with the advancement of network techniques. One of them is an IP terminal accommodating method, a gateway apparatus, a gatekeeper apparatus and an IP terminal disclosed in Japanese Patent Application Laid-Open No. 2001-285476. In this prior art, the gateway apparatus is connected to a base station connection line of a PBX so that the IP terminal connected to an IP network can be registered in a database in the PBX as a radiotelephone.

Another communication system is disclosed in Japanese Patent Application Laid-Open No. 2002-252668. In this system, an antenna of a PHS, a line controller for managing the IP address of the antenna, an H.323 terminal, and a gatekeeper for managing the IP address of the H.323 terminal are connected to LAN. The line controller performs protocol conversion between a PHS protocol and a VoIP protocol.

However, in the former prior art, the base station connection line of the PBX serves as a PBX line. Therefore, a gateway apparatus having a physical gateway function is required to connect the H.323 gatekeeper to the PBX.

Moreover, the latter prior art is intended to establish a system capable of mutual communication between a terminal compliant with the H.323 protocol and a terminal not compliant with the H.323 protocol. Namely, it is never assumed that a system with the H.323 gatekeeper and the H.323 terminal, the system being compliant with the H.323, is added to the existing system with the IP-PBX and the IP terminal.

### SUMMARY OF THE INVENTION

It is therefore an object of the present invention to provide an IP network system and an H.323 gatekeeper for easily performing voice communication between an existing system which does not use the H.323 protocol such as an IP-PBX system and a system which uses the H.323 protocol.

According to a first aspect of the present invention, for achieving the object mentioned above, there is provided An IP network system comprising:

an IP-PBX as an exchange compliant with an IP network;

an IP terminal device managed by the IP-PBX for performing communication over a PBX protocol defined by the IP-PBX;

an H.323 terminal device for performing communication over an H.323 protocol; and

an H.323 gatekeeper managing the H.323 terminal device over the H.323 protocol for performing protocol conversion between the PBX protocol and the H.323 protocol; wherein

the IP-PBX, the IP terminal device, the H.323 terminal device and the H.323 gatekeeper are connected to the same IP network.

According to a second aspect of the present invention, in the first aspect, the IP terminal device is a wireless base station.

According to a third aspect of the present invention, in the first or second aspect, the H323 terminal device deals with supplemental service functions compliant with H450 by the ITU-T recommendation.

According to a fourth aspect of the present invention, in the third aspect, the H.323 gatekeeper:

receives from the H.323 terminal device a service-use request message compliant with the H450;

converts the protocol of the received message from an H450 protocol to the PBX protocol to transmit the message to the IP-PBX;

receives from the IP-PBX a service-use response message compliant with the PBX protocol; and

converts the protocol of the received message from the PBX protocol to the H450 protocol to transmit the message to the H.323 terminal device.

According to a fifth aspect of the present invention, there is provided an H.323 gatekeeper connected via an IP network to a communication system employing a predetermined protocol other than the H.323 protocol, in compliance with an H.323 protocol, for:

managing an H.323 terminal device connected via the IP network; and

performing protocol conversion between the H.323 protocol and the protocol employed in the communication system to control voice communication between the H.323 terminal device and the communication system.

According to a sixth aspect of the present invention, in the fifth aspect, the H.323 gatekeeper:

receives from the H.323 terminal a service-use request message compliant with H450 by an ITU-T recommendation;

converts the protocol of the received message from an H450 protocol to the protocol employed in the communication system to transmit the message to the communication system;

receives from the communication system a service-use response message compliant with the protocol employed in the communication system; and

converts the protocol of the received message from the protocol employed in the communication system to the H450 protocol to transmit the message to the H.323 terminal device.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing a configuration of an IP network system according to an embodiment of the present invention;

FIG. 2 is a sequence diagram showing a flow of a terminal registration process by the H.323 terminal according to an embodiment of the present invention;

FIG. 3 is a sequence diagram showing a flow of a process leading up to an establishment of a voice channel according to an embodiment of the present invention; and

FIG. 4 is a sequence diagram showing a flow of a holding process during communication according to an embodiment of the present invention.

### DESCRIPTION OF THE PREFERRED EMBODIMENTS

Referring now to the drawings, embodiments of the present invention are explained in detail.

### CONFIGURATION OF EMBODIMENTS

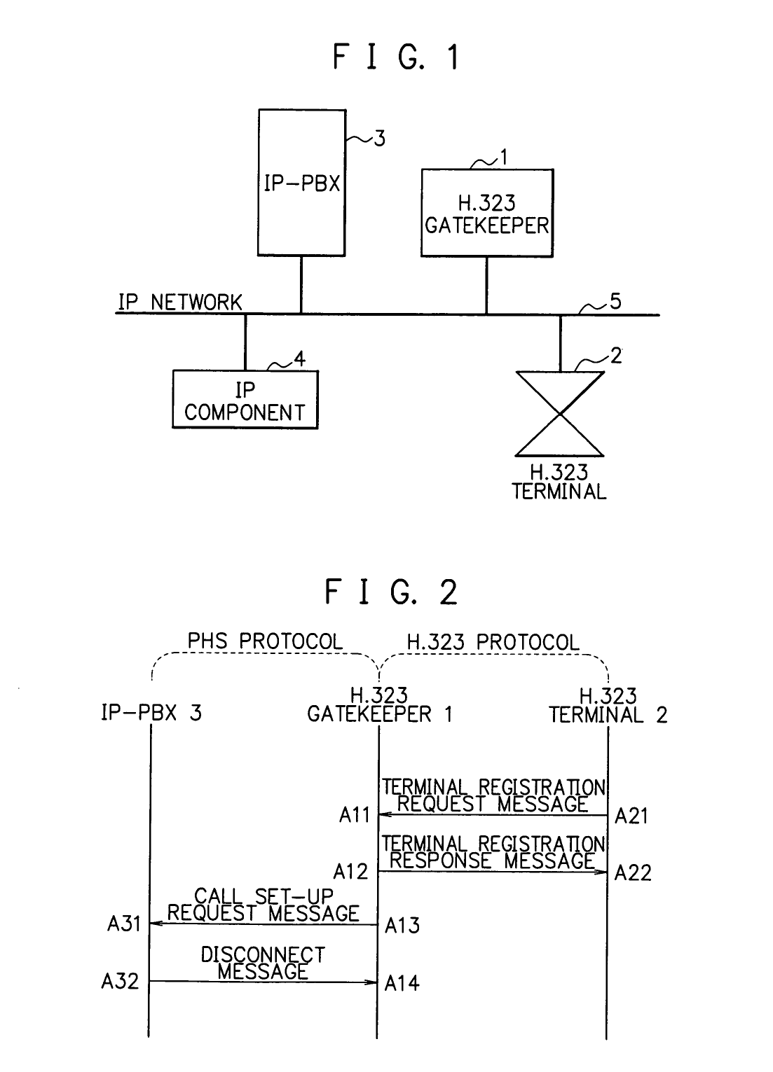

FIG. 1 is a diagram showing a configuration of an IP (Internet Protocol) network system according to an embodiment of the present invention. In the following, an explanation will be given of a configuration and operation of the IP network system in reference to FIG. 1.

The IP network system comprises an H.323 gatekeeper 1, an H.323 terminal 2, an IP-PBX (IP-Private Branch eXchange) 3, an IP component 4 and an IP network 5. The H.323 gatekeeper 1, the H.323 terminal 2, the IP-PBX 3 and the IP component 4 are connected to each other via the IP network 5.

An IP-PBX system is configured with the IP-PBX 3, the IP component 4 and the IP network 5. In the IP-PBX system, diverse services can be realized such as transfer, automatic transfer, hold, conference call, paging, direct incoming call and the like as with a conventional IP-PBX system. Incidentally, it is assumed that the same services such as transfer and hold as those rendered with H450 by ITU-T (International Telecommunication Union Telecommunication standardization sector) recommendation can be used in the IP-PBX system. In the following, an explanation will be given of the configuration of the IP-PBX system in the IP-PBX system.

The IP network 5 is an IP-based network such as LAN (Local Area Network).

The IP-PBX 3 is a private branch exchange compliant with the IP network 5 and manages an IP address (extension number) of a terminal under the control thereof (for example, the IP component 4). Moreover, the IP-PBX 3 controls a connection to a terminal under the control thereof (for example, the IP component 4) on the basis of a self-defined protocol (hereinafter referred to as a PHS (PBX) protocol).

The IP component 4 is a communication device placed on the IP network 5 under the control of the IP-PBX 3 and capable of mutual communication over the PHS protocol. For example, the IP component 4 may be a (wireless) base station, a PBX terminal (a communication terminal capable of operating over the PHS protocol), and the like. When serving as a base station, the IP component 4 may control a connection to a PHS terminal.

The H.323 gatekeeper 1 is an information processing unit that manages an IP address (extension number) of a terminal under the control thereof (for example, the H.323 terminal 2). The H.323 gatekeeper 1 has a means of managing and connecting each device (for example, H.323 terminal 2) over the H.323 protocol by the ITU-T recommendation. The H.323 gatekeeper 1 also has means of address translation, bandwidth management and the like, which are generally provided to a gatekeeper. Moreover, the H.323 gatekeeper 1 has a protocol conversion means that can be realized by a software. Furthermore, the H.323 gatekeeper 1 is in compliance with supplementary services compliant with H450 by ITU-T.

The H.323 terminal 2 is a communication device placed on the IP network 5 under the control of the H.323 gatekeeper 1 and has a means of mutual voice communication on the IP network 5 over the H.323 protocol. Moreover, the H.323 terminal 2 can use supplementary services compliant with H450 by ITU-T.

In the embodiments, a base station can be placed on the IP network in the system of the IP-PBX 3. In this system, the IP-PBX 3 registers therein the H.323 gatekeeper 1 as a virtual base station, and the H.323 terminal 2 under the control of the H.323 gatekeeper 1 as a virtual PHS terminal.

Moreover, in the embodiments, the H.323 gatekeeper 1 is provided with a gateway function to realize a protocol conversion function for converting the H.323 protocol to the PHS protocol defined by the IPPBX 3 and vice versa. By this means, it becomes possible to establish communication between the H.323 terminal 2 under the control of the H.323 gatekeeper 1 and the IP component 4 (a base station, a PBX terminal, etc.) placed on the IP network 5 under the control of the IP-PBX 3.

Furthermore, it becomes possible to realize a protocol conversion function for converting the H450 protocol by the ITU-T recommendation, by which the services over the H.323 protocol are standardized, into the PHS protocol and vice versa by the use of the gateway function provided to the H.323 gatekeeper 1. By this means, it becomes possible to realize services (transfer, hold, etc.) defined by H450 through operations of the H.323 terminal 2 that supports H450.

### Process of Registering H.323 Terminal in IP-PBX 3

It is necessary to register in the IP-PBX 3 the positional information of the H.323 terminal 2 (a virtual PHS terminal) to inform the IP-PBX 3 of the information about the H.323 terminal. By this means, the IP-PBX 3 can recognize the H.323 terminal 2 as a virtual PHS terminal. FIG. 2 is a sequence diagram showing a flow of a terminal registration process of the H.323 terminal 2 according to an embodiment of the present invention. In the following, an explanation will be given of a terminal registration (positional registration) process of registering the H.323 terminal 2 in the IP-PBX 3 by activating the H.323 terminal 2 in reference to FIGS. 1 and 2.

First, the H.323 terminal 2 transmits to the H.323 gatekeeper 1 a terminal registration request message indicating a request to register itself in the IP-PBX 3 (A21→A11).

In response to the terminal registration request message from the H.323 terminal 2, the H.323 gatekeeper 1 transmits to the H.323 terminal 2 a terminal registration response message indicating that the terminal registration is authorized or unauthorized (A12→A22). When receiving the terminal registration response message, the H.323 terminal 2 activates itself only when the message indicates “authorized”.

After transmitting the terminal registration response message indicating “authorized” to the H.323 terminal 2, the H.323 gatekeeper 1 transmits a call set-up request message to the IP-PBX 3 (A13→A31). The call set-up request message includes the extension number, the kind, etc. of the H.323 terminal 2.

When receiving the call set-up request message from the H.323 gatekeeper 1, the IP-PBX 3 executes positional registration processing of the H.323 terminal 2. The IP-PBX 3 transmits a disconnect message to the H.323 gatekeeper 1 (A32→A14). The disconnect message includes a result of the positional registration processing (normal end or inability to use services). When the result of the processing indicates the “normal end”, the H.323 gatekeeper 1 shifts to a state of allowing a transmission and reception to and from the registered extension number (the extension number of the H.323 terminal 2). On the other hand, when the result of the processing indicates the “inability to use services”, the H.323 gatekeeper 1 transmits a call set-up request message again after a predetermined time has passed.

### Process of Establishing Voice Channel between H.323 Terminal 2 and IP Component 4

The H.323 protocol is employed between the H.323 terminal 2 and the H.323 gatekeeper 1 to exchange signals. On the other hand, the PHS protocol is employed between the H.323 gatekeeper 1 and the IP-component 4 to do the same. The H.323 gatekeeper 1 performs protocol conversion between the above-described two protocols.

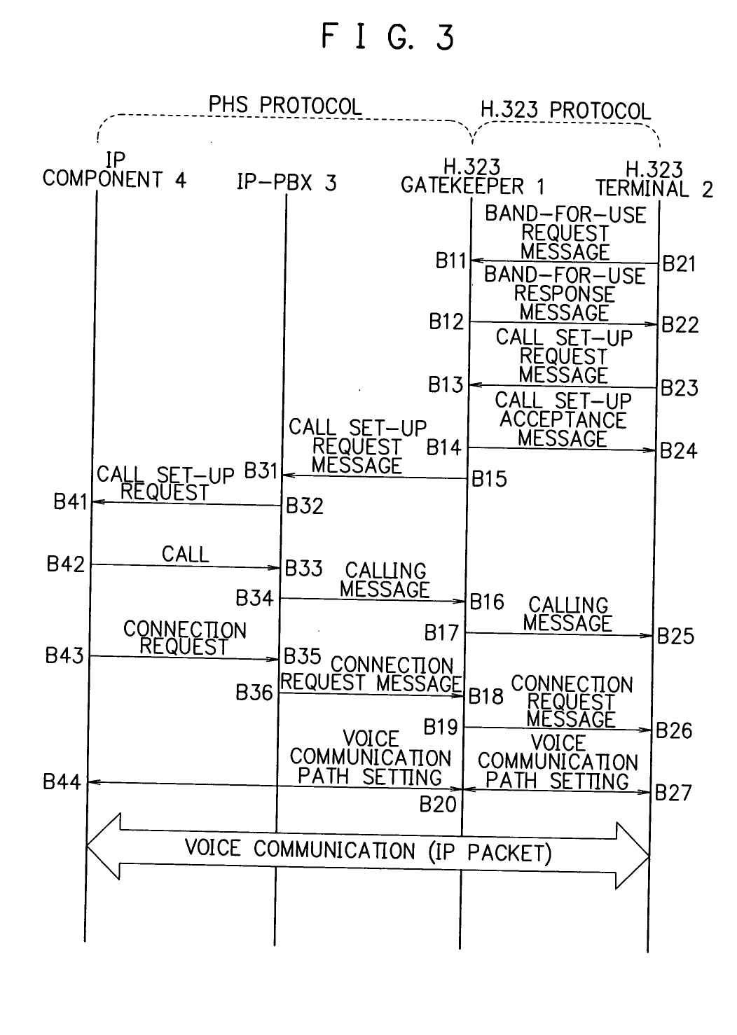

FIG. 3 is a sequence diagram showing a flow of a process leading up to an establishment of a voice channel according to an embodiment of the present invention. In the following, an explanation will be given of a process up to an establishment of the voice channel between the H.323 terminal 2 and the IP component 4 under the control of the IP-PBX 3 in reference to FIGS. 1 and 3.

First, the H.323 terminal 2 transmits a band-for-use request message to the H.323 gatekeeper 1 (B21→B11).

When receiving the band-for-use request message from the H.323 terminal 2, the H.323 gatekeeper 1 allocates a band for use to the H.323 terminal 2 and transmits a band-for-use response message to the H.323 terminal 2 (B12→B22).

Subsequently, the H.323 terminal 2 transmits a call set-up request message to the H.323 gatekeeper 1 (B23→B13). The call set-up request message includes an extension number of a called terminal (at the side of the IP component 4).

After that, the H.323 gatekeeper 1 transmits a call set-up acceptance message to the H.323 terminal 2 (B14→B24). The H.323 gatekeeper 1 converts the protocol of the call set-up request message received from the H.323 terminal 2 from the H.323 protocol into the PHS protocol to compose a PHS protocol call set-up request message. The H.323 gatekeeper 1 transmits the composed PHS protocol call set-up request message to the IP-PBX 3 (B15→B31).

When receiving the PHS protocol call set-up request message from the H.323 gatekeeper 1, the IP-PBX 3 transmits a call set-up request to the IP component 4 (B32→B41).

When receiving the call set-up request from the IP-PBX 3, the IP component 4 returns a “call” to the IP-PBX 3 if communication is possible (B42→B33).

When the IP-PBX 3 receives the “call” from the IP component 4, namely, when the IP component 4 is allowed to be called, the IP-PBX 3 transmits a calling message to the H.323 gatekeeper 1 (B34→B16).

Subsequently, the H.323 gatekeeper 1 converts the protocol of the received calling message from the PHS protocol to the H.323 protocol to compose an H.323 protocol calling message. The H.323 gatekeeper 1 transmits the composed H.323 protocol calling message to the H.323 terminal 2 (B17→B25).

Subsequently, the IP component 4 transmits a connection request to the IP-PBX 3 in response to the incoming call (B43→B35).

When receiving the connection request from the IP component 4, the IP-PBX 3 transmits a connection request message to the H.323 gatekeeper 1 (B36→B18).

The H.323 gatekeeper 1 converts the protocol of the received connection request message from the PHS protocol to the H.323 protocol to compose a H.323 protocol connection request message. Subsequently, the H.323 gatekeeper 1 transmits the composed H.323 protocol connection request message to the H.323 terminal 2 (B19→B26).

When the H.323 terminal 2 receives the connection request message from the H.323 gatekeeper 1, a process of setting up voice communication paths between the H.323 terminal 2 and the IP component 4 is executed (B44←→B20, B20←→B27). All of the respective signals for the process of setting up the voice communication paths go through the H.323 gatekeeper 1 so that the respective protocols of the signals can be converted.

After the voice communication path setting-up process, voice communication (IP packets) is performed between the H.323 terminal 2 and the IP component 4.

### Process of Hold During Communication

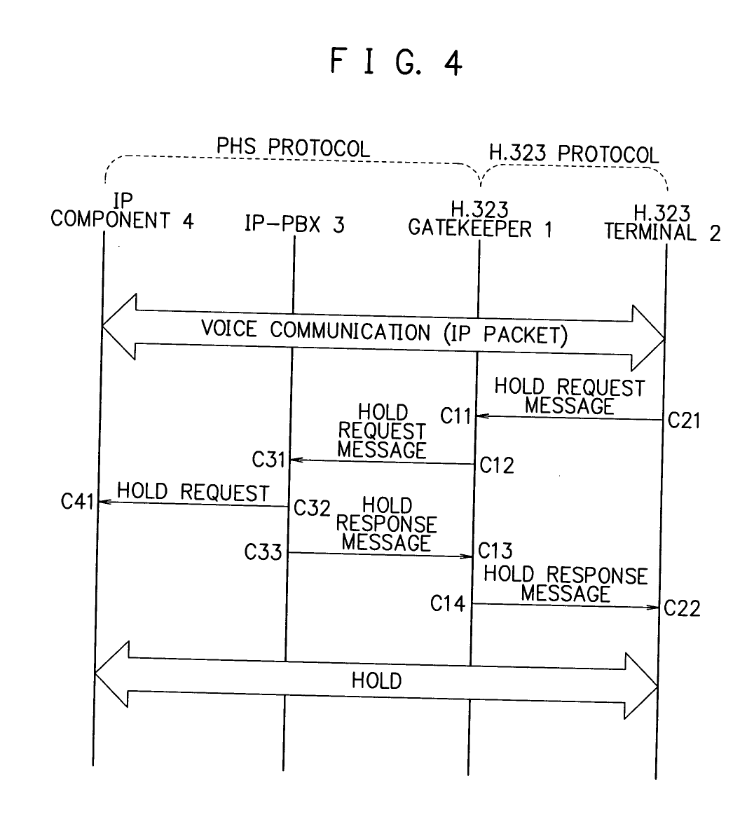

FIG. 4 is a sequence diagram showing a flow of a holding process during communication according to an embodiment of the present invention. In the following, an explanation will be given of a process when the H.323 terminal 2 requests a hold during communication between the H.323 terminal 2 and the IP component 4 as an example of services rendered with the H450 procedures. Incidentally, “hold” is defined by H450.4 in terms of a H450 series by the ITU-T recommendation.

First, the H.323 terminal 2 transmits a hold request message to the H.323 gatekeeper 1 during voice communication (IP packets) with the IP component 4 (C21→C11). This hold request message is compliant with a format defined by H450.

The H.323 gatekeeper 1 performs protocol conversion from the H.323 (H450) protocol to the PHS protocol to compose a PHS protocol hold request message. The H.323 gatekeeper 1 transmits the composed PHS protocol hold request message to the IP-PBX 3 (C12→C31).

When receiving the PHS protocol hold request message from the H.323 gatekeeper 1, the IP-PBX 3 transmits a hold notification (hold request) to the IP component 4 (C32→C41).

After transmitting the hold notification to the IP component 4, the IP-PBX 3 transmits a hold response message to the H.323 gatekeeper 1 (C33→C13).

The H.323 gatekeeper 1 converts the protocol of the received hold response message from the PHS protocol to the H.323 (H450) protocol to compose an H.323 (H450) protocol hold response message. Subsequently, the H.323 gatekeeper 1 transmits the composed H.323 (H450) protocol hold response message to the H.323 terminal 2 (C14→C22).

Subsequently, the voice communication between the H.323 terminal 2 and the IP component 4 enters into a hold state.

Incidentally, while in this embodiment a call hold supplementary service by H450.4 (hold) has been explained, the other supplementary services compliant with H450 can also be realized. For example, a call transfer supplementary service by H450.2 (transfer), a call diversion supplementary service by H450.3 (absence transfer/telephone transfer), a call park and call pickup supplementary service by H450.5, a call waiting supplementary service by H450.6, a message waiting indication supplementary service by H450.7 and the like can be realized in this embodiment.

As described hereinbefore, according to the embodiments, the IP network 5 is provided with the H.323 gatekeeper 1, the H.323 terminal 2, the IP-PBX 3 and the IP component 4. Moreover, the H.323 gatekeeper 1 is provided with a software to fulfill the protocol conversion function. Accordingly, it becomes possible to perform communication between the H.323 terminal 2 under the control of the H.323 gatekeeper 1 and the IP component 4 under the control of the IP-PBX 3 without placing a gateway device (hardware) between the H.323 gatekeeper 1 and the IPPBX 3.

Moreover, it becomes possible to reduce the time and the number of outgoing packets leading up to establishing communication between the H.323 terminal 2 and the IP component 4. This is because there is no need to place a gateway device between the H.323 gatekeeper 1 and the IP-PBX 3.

Further, according to the embodiments, the H.323 gatekeeper 1 stores a program for protocol conversion between the H.323 protocol and the other protocol. Accordingly, when a system configured with an H.323 gatekeeper 1 and an H.323 terminal 2 is additionally connected to the IP network 5 in the existing IP-PBX system, it becomes possible to reduce the workload on the IP-PBX 3 in comparison with the case where the IP-PBX 3 stores therein the protocol conversion program.

Furthermore, conventionally, various services were realized only in conformity with a specification defined at the side of the H.323 gatekeeper (for example, a rule to determine an INFO message as a hooking request message). Namely, an H.323 terminal not compliant with the specification could not control and enjoy the services. However, according to the embodiment of the present invention, the H.323 terminal 2 is a communication terminal that supports the H450 procedures. Moreover, the H.323 gatekeeper 1 performs protocol conversion between the H450 (H.323) protocol and the PHS protocol. Accordingly, the H.323 terminal 2 is allowed with the IP component 4 to easily utilize the services such as transfer and hold, which are standardized by H450, without any compliance with the specification defined by the H.323 gatekeeper 1.

Moreover, the above-described processing is executed by a computer program included in the H.323 gatekeeper 1, H.323 terminal 2, IP-PBX 3 and the IP component 4, respectively. The program may be recorded in a storage medium such as an optical recording medium, a magnetic recording medium, a magnet-optical recording medium or a semiconductor to be loaded therefrom. On the other hand, the program may be loaded from an external device connected via a predetermined network.

As set forth hereinbefore, according to the present invention, an H.323 gatekeeper, an H.323 terminal device, an IP-PBX and an IP terminal device are placed on an IP network. Moreover, the H.323 gatekeeper has a protocol conversion function. Accordingly, it becomes possible to establish communication between the H.323 terminal device under the control of the H.323 gatekeeper and the IP terminal device under the control of the IP-PBX without installing a gateway device (hardware) between the H.323 gatekeeper and the IP-PBX.

Moreover, it becomes possible to reduce the time and the number of outgoing packets leading up to establishing communication between the H.323 terminal device and the IP terminal device. This is because it is not necessary to place a gateway device between the H.323 gatekeeper and the IP-PBX.

Further, according to the present invention, the H.323 gatekeeper performs protocol conversion between the H.323 protocol and the other protocol. By this means, when a system that comprises an H.323 gatekeeper and an H.323 terminal device is to be added to the IP network in the existing IP-PBX system, it becomes possible to reduce the burden of the IP-PBX in comparison with a case where the IP-PBX includes therein a protocol conversion function.

Furthermore, according to the present invention, the H.323 terminal device is a communication terminal that supports H450 procedures. In addition, the H.323 gatekeeper converts the H450 (H.323) protocol into the PHS protocol and vice versa. Accordingly, the H-323 terminal device does not have to be compliant with a specification defined at the side of the H.323 gatekeeper. Namely, the H.323 terminal device can utilize the services such as transfer and hold, which are standardized by H450, with the IP terminal device.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An IP network system comprising:
an IP-PBX as an exchange compliant with an IP network;
an IP terminal device managed by the IP-PBX for performing communication over a PBX protocol defined by the IP-PBX;
an H.323 terminal device for performing communication over an H.323 protocol; and
an H.323 gatekeeper managing the H.323 terminal device over the H.323 protocol for performing protocol conversion between the PBX protocol and the H.323 protocol, wherein:
the IP-PBX, the IP terminal device, the H.323 terminal device and the H.323 gatekeeper are connected to the same IP network.

2. An IP network system comprising:
an IP-PBX as an exchange compliant with an IP network;
an IP terminal device managed by the IP-PBX for performing communication over a PBX protocol defined by the IP-PBX;
an H.323 terminal device for performing communication over an H.323 protocol; and
an H.323 gatekeeper managing the H.323 terminal device over the H.323 protocol for performing protocol conversion between the PBX protocol and the H.323 protocol, wherein:
the IP-PBX, the IP terminal device, the H.323 terminal device and the H.323 gatekeeper are connected to the same IP network; and
the IP terminal device is a wireless base station.

3. An IP network system comprising:
an IP-PBX as an exchange compliant with an IP network;
an IP terminal device managed by the IP-PBX for performing communication over a PBX protocol defined by the IP-PBX;
an H.323 terminal device for performing communication over an H.323 protocol; and
an H.323 gatekeeper managing the H.323 terminal device over the H.323 protocol for performing protocol conversion between the PBX protocol and the H.323 protocol, wherein:
the IP-PBX, the IP terminal device, the H.323 terminal device and the H.323 gatekeeper are connected to the same IP network; and
the H323 terminal device deals with supplemental service functions compliant with H450 by the ITU-T recommendation.

4. An IP network system comprising:
an IP-PBX as an exchange compliant with an IP network;
an IP terminal device managed by the IP-PBX for performing communication over a PBX protocol defined by the IP-PBX;
an H.323 terminal device for performing communication over an H.323 protocol; and
an H.323 gatekeeper managing the H.323 terminal device over the H.323 protocol for performing protocol conversion between the PBX protocol and the H.323 protocol, wherein:
the IP-PBX, the IP terminal device, the H.323 terminal device and the H.323 gatekeeper are connected to the same IP network;
the IP terminal device is a wireless base station; and
the H323 terminal device deals with supplemental service functions compliant with H450 by the ITU-T recommendation.

5. An IP network system as claimed in claim 3, wherein the H.323 gatekeeper:
receives from the H.323 terminal device a service-use request message compliant with the H450;
converts the protocol of the received message from an H450 protocol to the PBX protocol to transmit the message to the IP-PBX;
receives from the IP-PBX a service-use response message compliant with the PBX protocol; and
converts the protocol of the received message from the PBX protocol to the H450 protocol to transmit the message to the H.323 terminal device.

6. An IP network system as claimed in claim 4, wherein the H.323 gatekeeper:
receives from the H.323 terminal device a service-use request message compliant with the H450;
converts the protocol of the received message from an H450 protocol to the PBX protocol to transmit the message to the IP-PBX;
receives from the IP-PBX a service-use response message compliant with the PBX protocol; and
converts the protocol of the received message from the PBX protocol to the H450 protocol to transmit the message to the H.323 terminal device.

7. An H.323 gatekeeper connected via an IP network to a communication system employing a predetermined protocol other than the H.323 protocol, in compliance with an H.323 protocol, for:
managing an H.323 terminal device connected via the IP network; and
performing protocol conversion between the H.323 protocol and the protocol employed in the communication system to control voice communication between the H.323 terminal device and the communication system.

8. An H.323 gatekeeper as claimed in claim 7, for:
receiving from the H.323 terminal a service-use request message compliant with H450 by the ITU-T recommendation;
converting the protocol of the received message from an H450 protocol to the protocol employed in the communication system to transmit the message to the communication system;
receiving from the communication system a service-use response message compliant with the protocol employed in the communication system; and
converting the protocol of the received message from the protocol employed in the communication system to the H450 protocol to transmit the message to the H.323 terminal device.
